(19) United States
(12) Patent Application Publication
(10) Pub. No.: US 2013/0047477 A1
(43) Pub. Date: Feb. 28, 2013

(54) Roadway Safety Awareness Method

(71) Applicant: Lateefah Conner, Kennesaw, GA (US)

(72) Inventor: Lateefah Conner, Kennesaw, GA (US)

(21) Appl. No.: 13/596,408

(22) Filed: Aug. 28, 2012

Related U.S. Application Data
(60) Provisional application No. 61/528,470, filed on Aug. 29, 2011.

(51) Int. Cl. G09F 19/02; G09F 21/04; G09F 7/00

(52) U.S. Cl. 40/412; 40/612; 40/591

(57) ABSTRACT

Disclosed is a method of improving roadway safety by increasing societal awareness and providing a recognizable symbol or figure that alerts motorists of upcoming roadway hazards, construction sites and broken down vehicles and triggers a compliant response. The method includes the introduction of a safety alert figure or symbol, which can be utilized in a broad marketing, advertising and educational campaign for the purposes of increasing roadway safety and awareness, particularly for commonly dangerous roadway environments involving motorists and pedestrians or roadway workers. The method also comprises the physical implementation of the figure as a roadway sign, alerting motorists and directing traffic while affiliating the sign with the campaigned figure. The goal is to increase roadway awareness, increase motorist compliance with roadway signs and reduce the instances of injury or fatality as a result of roadway collisions in these environments.

### CROSS REFERENCE TO RELATED APPLICATION

This application claims the benefit of U.S. Provisional Application No. 61/528,470 filed on Aug. 29, 2011, entitled “Safety Alert Man (S.A.M.).” The above identified patent application is herein incorporated by reference in its entirety to provide continuity of disclosure.

### BACKGROUND OF THE INVENTION

1. Field of the Invention

The present invention relates to traffic control signs, hazard warning signals and roadway safety for construction sites and broken down vehicles along roadway shoulders. More specifically, the present invention relates to a method of informing and reminding the public of roadway safety while approaching a construction site or roadway hazard, utilizing a recognizable figure and marketing campaign directed to slow down motorists or increase awareness along roadways with construction workers or broken down motorists outside of their vehicles.

Motorists and unprotected individuals along roadways are subjected to hazardous conditions and potentially dangerous situations, as motorists are may be moving at a rate of speed that would cause significant injury or death if the individual was to be struck by the vehicle. For this reason, it is well understood that roadway construction crew safety and broken down vehicle warning systems are imperative to the safety not only of the unprotected individual, but also the motorist, nearby motorists in secondary collisions and the nearby property. Roadside construction is a particularly dangerous environment, where many construction workers walk along a road that may still be in use while conducting their work activities. Motorists and construction workers can become easily distracted from taking simple safety precautions or may not realize the peril they are under in the moment. Further examples include busy intersection or roadway cross walks, where individuals or families may desire, and have the right away across a roadway. The danger of an uninformed or distracted motorist can lead to significant collisions and compromises in safety. A final situation that is commonly perilous along a roadway is the case of a broken down vehicle, in the case of a deflated tire or failed drive component that renders the vehicle un-drivable or in need of roadside maintenance. Along roads having little to no shoulder run-off and along busy or high speed roads, this condition can quickly become deadly, as the user may be required to both watch for oncoming vehicles while performing a wheel change or similar maintenance.

These common roadways situations are a public health and safety concern, as they result in many injuries each year as a result of several contributing factors, often including careless driving, insufficient notice prior to a construction site or roadway hazard, careless roadside individuals, among many others. Common means of protecting all individuals involved, including pedestrians, roadway workers, broken down motorists and the traveling motorist include varying levels of roadway warnings that are directed to the motorists passing. It is common to see several posted signs and traffic control operators when entering and exiting a construction site. For broken down motorists, vehicles deploy their hazard lights and some other are further equipped with roadway hazard signs or flares that can be posted in advance of the vehicle. And finally, static roadway signs are commonly place in busy intersections or along busy roads having pedestrian crossings to alert drivers that they must yield to pedestrian crossers.

It is recognized that these signs are deployed as a means of warning motorists in an attempt to raise situational awareness and reduce vehicle speeds, with the hope that motorists will proceed with increased caution and undivided attention to their surroundings. However, it is submitted that existing signs and methods of warning motorists of upcoming roadway hazards lack the means to convey the severity of the roadway environment ahead in such a way that motorists respect the signage directions and to obtain the motorists' undivided attention. The present invention pertains to a method of roadway emergency, construction or hazard warning that utilizes a readily recognizable character employing a sign directed to the pass motorists. The method combines a marketing campaign using a readily recognizable figure that can be taught to both young and old adults for the purposes of increasing awareness to an existing problem of roadway safety. The character is then utilized as a means to warn motorists in the actual roadway environment, where various inflatable static and dynamically moving sign figures provide warnings to motorists. The recognition of the figure by the motorists and relating it to the issue of roadway safety as an overall societal concern conveys the severity of situation, its hazards and its associated penalties for noncompliance. It is desired that construction companies, local communities or larger government entities such as state transportation agencies would distribute an awareness campaign that links to the roadside figures used as a means of controlling traffic.

2. Description of the Prior Art

Devices have been disclosed in the prior art that relate to roadway construction and broken down vehicle signs. These include devices that have been patented and published in patent application publications, and generally relate to inflatable, planar and erectable signs for various purposes and with varying features for drawing attention, warning motorists or directing traffic. Many relate to inflatable signs for marketing purposes only. These devices fail to disclose the primary concern of the present invention, coupling a readily recognizable figure and sign with a marketing campaign that addresses the public safety concern of roadway hazards and construction site safety. The forgoing is a list of devices deemed most relevant to the present disclosure, which are herein described for the purposes of highlighting and differentiating the unique aspects of the present invention, and further highlighting the drawbacks existing in the prior art.

The first of such devices includes U.S. Pat. No. 3,250,241 to Levy, which discloses an inflatable emergency traffic signal unit that provides a means to warn traveling motorist of a broken down vehicle or emergency roadside situation that may require outside assistance or motorist caution when passing. The device includes an inflatable member that includes a nozzle attachable to the air valve of a vehicle tire to inflate the member, after which the inflated member is mounted to a support on top of the vehicle or upstream therefrom as a warning sign. The support comprises an elongated wire support post having a top loop and a suction cup base or base suitable for supporting the inflated member in an upright position. The present invention pertains to a method of employing inflatable characters and signs that represent roadside warning markers for nearby motorists in the event of a vehicle breakdown, collision or roadway construction.

Another such device is U.S. Pat. No. 4,995,186 to Collie, disclosing an inflatable warning sign adapted for vehicle use that includes a flashing light and a magnetic base for connection to the car body. The inflated shape is one of a prismatic triangle having a message thereon and an interior incandescent light bulb for illumination of the sign in low light conditions. Power is supplied to the bulb using vehicle electrical direct current power. When folded, the assembly occupies a volume that easily fits within the glove compartment of a motor vehicle. While the Collie device provides a convenient hazard light for a broken down vehicle, it provides no means of alerting motorists in advance of a roadside hazards or one that is suitable for use as a construction sites traffic warning system.

U.S. Pat. No. 3,892,081 to Goral discloses an inflatable and portable sign that serves as a roadway marker, signal or advertising sign. The device comprises a support post having a sharpened lower end for insertion into a ground surface, an air valve along an opposing end and a balloon having a sign printed thereon detachably affixed to the end of the air valve. An air intake on the air valve allows connection to a compressed air source for inflating the balloon to a desired diameter, sizing the balloon to allow visibility of the imprinted sign thereon. Along the post is a projection that allows connection to a levered jack for removal of the post from a ground surface after insertion, facilitating ease of removal for the user without strain. The Goral device is one that can be utilized as a general advertizing sign and requires soft ground for use. The present invention contemplates a more encompassing roadway safety method using an inflatable or otherwise roadside figure structure that emphasizes safety and the public concerns over roadway fatalities and construction worker hazards.

Further disclosed is U.S. Pat. No. 7,198,538 to Chin-Cheng, which describes a displayable and inflatable figure having a hollow main body comprising of a soft, air permeable fabric, along with an internal fan assembly and lighting assembly to inflate and illuminate the body in operation. The fan continuously pumps air into the body, while excessive air after the body is completely inflated is leaked out through the air permeable fabric to retain a defined shape. In this way, the device allows for an inflated character with internal illumination that sustains its shape as long as the fan is continuously operating. While disclosing a novel sign using forced air and an inflated figure, the Chin-Cheng device is more closely related to a lawn decoration than a roadside warning system. The present invention contemplates several figure designs and devices for implementation therefor, but is directed to warning passing motorists of upcoming roadway environments and directing motorists to a particular action.

U.S. Pat. No. 7,380,360 to Evans is another such device that discloses a road sign comprising a planar cut-out figure bearing a sign to attract the attention of passing by individuals or motorists. The planar cut-out includes the shape of a child having a head, arms and legs, while the arms support a sign having indicia thereon adapted to be read by passing by individuals. The base is coupled to the cut-out legs and comprises a plurality of members having a first and second notch, the legs coupled with at least one notch of the members for supporting the planar cut-out in an upright configuration. The sign may be removable from the arms of the figure to allow flexibility with respect to the device's message. An accompanying method of using a planar figure is disclosed for displaying directions or a sign for passersby.

Finally, U.S. Pat. No. 5,001,475 to Scovin discloses a portable, ground-supported automobile traffic control device that comprises an upright figure in the shape of a human to simulate a traffic control officer. Adjacent to the human figure is a traffic light signal that is operable using an automatic controller to signal stop, stop and go, or other displays for motorists to follow. The figure simulates a worker operating the signal, while the signal operates based on a defined controller for controlled traffic flow within the vicinity of the figure. The figure and traffic signal is a mirror image with two opposing signals and figures for controlling two-way traffic approaching from opposite directions.

The present invention provides a means of increasing roadway safety awareness amongst the public and connecting in people's mind the roadway safety figure with the physical figure being utilized along the road for the purpose of garnering more attention to the issue of safety in these conditions than is currently given. It is submitted that the elements of the present invention and the steps of its method are substantially divergent in elements from the prior art, and consequently it is clear that there is a need in the art for an improvement to existing roadway safety device and methods. In this regard the instant invention substantially fulfills these needs.

### SUMMARY OF THE INVENTION

In view of the foregoing disadvantages inherent in the known types of roadway safety methods and signs now present in the prior art, the present invention provides a new method of roadway safety awareness and compliance, wherein the same can be utilized for providing increased pedestrian, motorist and roadway worker safety.

It is therefore an object of the present invention to provide a new and improved roadway safety method that has all of the advantages of the prior art and none of the disadvantages.

It is another object of the present invention to provide a roadway safety method that utilizes a recognizable figure and direction to passing motorist, alerting them of an upcoming hazard, condition or construction site.

Another object of the present invention is to provide a roadway safety method that utilizes a highly marketed and advertised roadway safety character that becomes recognizable as a symbol of roadway safety and awareness, the character being physically deployed along roadways to increase compliance while educating the public of the current safety issue.

Yet another object of the present invention is to provide a roadway safety method that includes a physical and fictional figures that is utilized as a means of reducing injuries and fatalities that result from roadway environments that mix pedestrians and workers with motorists in large vehicles.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart of the present method and an example of its implementation.

FIG. 2 shows an embodiment of the method character utilized along a roadway.

FIG. 3 shows a second embodiment of the method character utilized along a roadway.

FIG. 4 shows a third embodiment of the method character utilized along a roadway.

FIG. 5 shows the first embodiment of the method character being deployed along a roadway construction site.

FIG. 6 shows the second embodiment of the method character being deployed along a roadway to alert motorists of a broken down vehicle.

### DETAILED DESCRIPTION OF THE INVENTION

Reference is made herein to the attached drawings. Like reference numerals are used throughout the drawings to depict like or similar elements of the roadway safety method. For the purposes of presenting a brief and clear description of the present invention, the preferred embodiment will be discussed as used for increasing public awareness, education and compliance with roadway warning signs and increasing public safety along roadways. The figures are intended for representative purposes only and should not be considered to be limiting in any respect.

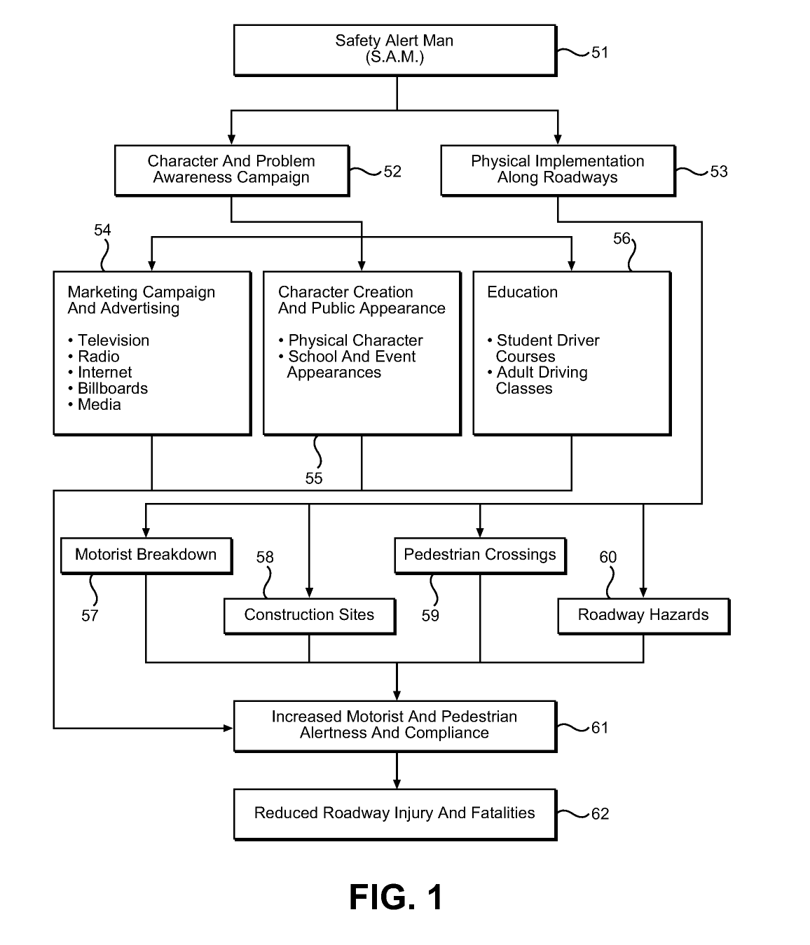

Referring now to FIG. 1, there is shown a flow diagram outlining an embodiment of the disclosed method, wherein a ‘Safety Alert Man’ character, or ‘S.A.M.’, is created using a two-pronged approach: public awareness 52 and roadway implementation 53. The character is one that is adapted to become readily recognizable as a symbol of roadway safety, increased awareness in dangerous roadway environments and increased vigilance when approaching an area with pedestrians, workers or a broken down vehicle. Building awareness and the character that will convey the current hazards and public safety concern is one that is cartoonish and likeable for young people and older individuals, wherein the message is conveyed through a creative marketing, development and education campaign. The goal is to introduce the public to the long-standing issues with reckless driving behavior and the common ignorance of roadway signs, which can lead to significant injury, property damage and even death.

A marketing and advertising campaign 54 directed to introducing the S.A.M. character may be publically or privately funded, wherein the character is introduced and the topics of public safety on roadways is discussed in commercials through various types of media. Longer segments and advertisements directed to younger drivers may also be effective for introducing these topics early in one's driving years. At the same time, the character may take physical form and make public appearances or events 55, spreading the word of roadway safety in person, perhaps during sporting events and even appearances at high schools with driving teens. Finally, an educational aspect is desired, where booklets and information may be available for those learning to drive, taking driving lessons or those in driving courses for all ages. In this phase of the method, the character of S.A.M. is introduced and developed to ingrain the character's purpose and the message to the public, whereafter the physical implementation 53 of the character is linked to the awareness and educational campaign.

The physical implementation of the character is desired to draw a link between the visualization of the S.A.M. character and the marketing campaign, which emphasizes the importance of safety and the hazards of carelessness in roadways situations involving moving vehicles and unprotected individuals. It is desired to implement different style inflatable signs, planar signs, static and dynamic signs of the figure along a roadway to warn motorists of an upcoming hazard or to direct them to a specific command, such as reducing speed and paying attention to roadway workers. Some common situations in which such a physically implemented character and roadway warning system may be deployed are during motorist breakdowns 57, prior to and along roadway construction sites 58, at pedestrian crossings across busy streets, and finally to warn motorists of an upcoming roadway hazard 60 such as a large pot hole, downed tree or similar situation. The character is incorporated into the roadway signal, along with a message or direction for motorists, with the goal of alerting the public of an upcoming roadway condition that is commonly hazardous, as described by the S.A.M. character in the awareness campaign. Finally, through the use of the awareness campaign and the physical implementation, it is desired to increase motorist and pedestrian alertness, awareness of their surroundings along roadways and compliance with all laws and directions along roadways. The end goal is to reduce roadway injury, fatalities and property damage resulting from roadways accidents, collisions and other scenarios that otherwise could have been avoided.

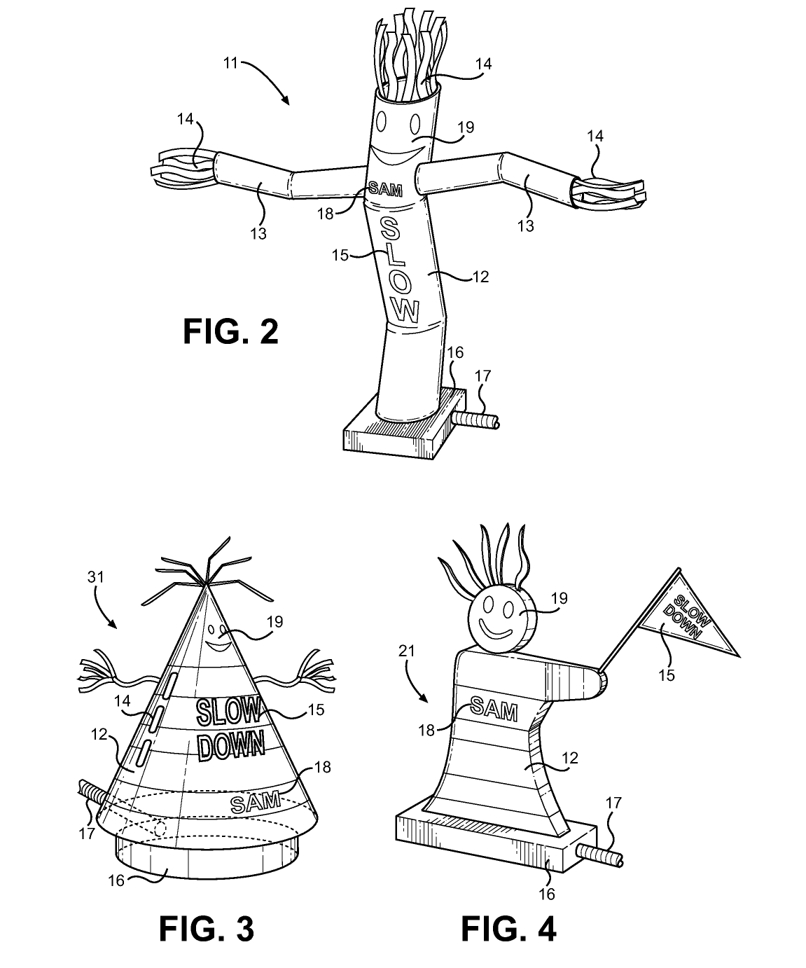

Referring now to FIG. 2, there is shown an embodiment of the present method character and a physical implementation thereof. This embodiment contemplates the use of a constant blower motor connection 17, which directs pressurized air into a tubular character 11 from its base 16 and into its upstanding body portion 12 and lateral arm portions 13. Along the body section 12 is a motorist direction 15 and the name of the character 18, while a face 19 above the arm portions is the same as the S.A.M. character. As air is blown into the body of the device, the figure dynamically moves to draw attention, while the sign 15 and the look of the character provide a quick reminder of the intent of the figure: safety and roadway awareness. At the terminal ends 14 of the tubular body and arm portions are openings that allow the pressurized air to escape. This embodiment requires a blower motor to continuously inflate the body of the figure, while the figure itself is particularly sized and suited for construction site and long term deployment, as opposed to short term or individual use.

Referring now to FIGS. 3 and 4, there are shown two embodiments of smaller, individual-use figure sign embodiments of the present invention. In these embodiments, a tapering sign 31 and a figure holding a sign 21 are shown. The tapering sign may be an inflatable structure that utilizes a foot pump connection 17, or further a continuous blower motor connection 17 that blows air into the figure body and through vent holes 14 along its upper section. For the figure holding a sign, the body section 12 is inflatable using a hand or foot pump connection 17, wherein the body 12 retains pressurized air therein for a static sign. This embodiment is in the shape of a character having a body 12, a face 19 and an arm portion holding a sign 15. The sign 15 directs motorists passing thereby. Similarly, the inflatable, tapering embodiment includes a sign 15 along its body section 12 and a character face 19 along its upper portion. Both embodiments include a base 16 that supports the figure in an upright and stable configuration, while further allowing air to be directed into the body 12 of the device.

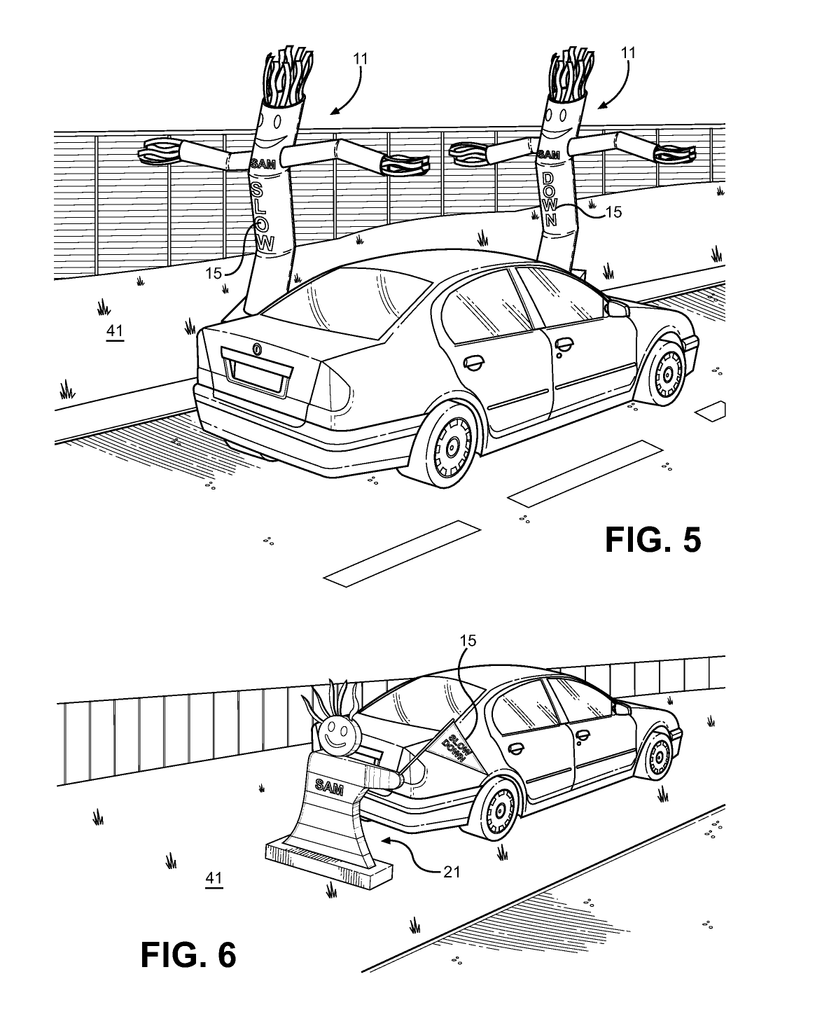

Referring now to FIG. 5, there is shown a view of an embodiment of the physical implementation of the present invention along a roadway using constant blow motor characters 11. The characters 11 are positioned along the side 41 of a roadway in advance of an upcoming construction site or roadway environment requiring motorists to take caution. The signs include directions 15 to the motorists to increase awareness and safety approaching the roadway condition or construction site following the signs 11. It is desired that the physical characters 11 become linked to the educational and awareness campaign that reinforces careful driving and awareness around roadway construction sites and other hazardous roadway environments. Referring now to FIG. 6, there is shown a view of an embodiment of the physical implementation of the present invention along a roadway using a static FIG. 21 embodiment. This embodiment is contemplated for use by individuals for broken down vehicle situations, wherein the figure and warning symbol can be deployed from the vehicle, inflating the FIG. 21 to an inflated state and placing it in advance of the vehicle requiring repair. This embodiment may also be utilized at pedestrian crossings or at other locations not desiring a dynamically moving sign.

When traveling along a highway, it can be easy to overlook the signs that are posted when approaching a construction zone. Some motorists ignore posted signs, resulting in dangerous interactions between high speed vehicles and construction workers, which can lead to injury, death and property damage resulting from the actions of an oblivious driver. When an individual's car breaks down and he or she must pull over to the shoulder of the road, it can be a dangerous situation, as passing motorists may be unable to see the stranded automobile or inadequate shoulder space may be provided. High speed vehicles passing the broken down vehicle without proper notice is dangerous, and can lead to traffic collisions or the motorists breaking rapidly or changing lanes abruptly. The present method is designed to alert motorists of roadside emergencies and environment utilizing a physical character that is linked to an awareness campaign that teaches driving safety and obedience to all traffic signs and warnings. The present invention may utilize static figures or dynamically moving characters along roadways, wherein a message is conveyed directly and indirectly by way of traffic commands and through the teachings of the awareness campaign, respectively. Reflective signs catch the attention of passing drivers in night or day, wherein the motorist quickly realizes he or she must slow down or obey the traffic signs. The device may replace the smaller and less recognizable signs that are placed before a construction worksite or broken down car. State transportation agencies and motorists will both benefit through the increased awareness campaign and deployment of the associated character, wherein roadway collisions, injuries and property damage. Children and young drivers will also learn about roadside safety though the S.A.M. character, who may also be utilized as a mascot by transportation agencies or construction companies.

The S.A.M. character effectively alerts motorists when approaching construction zones or road hazards and links the sign to an awareness program that introduced the figure itself and the importance of driving safety and traffic sign compliance. The physical character and roadway implementation may be provided in a number of different versions that have the same goal of increasing road safety. A dynamic “S.A.M.” may be made of lightweight material that may be able to be propelled upwards, giving it the shape of a stick figure when placed on a powerful operated blower fan. Orange fabric making the body of the character moves freely to makes the character dynamic and eye catching, having the word “S.A.M” on its chest along with “SLOW DOWN” directions or similar directions in reflective lettering. The device may also be illuminated at night. Stationary “S.A.M.” may be in the shape of a cone and have a magnetized bottom or be in the shape of a static figure. It may be placed along roadways, at pedestrian crossings, on the roof a vehicle or in advance thereof. State transportation agencies may utilize a physical character in costume form, similar to crime fighting awareness campaign slogans and characters. The mascot educates young children and teen drivers about road safety, sign obedience, pedestrian safety and safety tips when traveling through construction sites.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of improving roadway safety and promoting roadway safety awareness, comprising the steps of:
creating a roadway safety character;
engaging in an awareness campaign that allows character to teach roadway safety and spread awareness of roadway safety as an issue;
physically implementation of said character through signs utilizing said character along roadways, said sign having indicia thereon for traffic commands or warning symbols;
establishing a recognizable link between said awareness campaign and said physical implementation to increase motorist compliance and roadway safety.

2) The device of claim 1, wherein said roadway safety character comprising a Safety Alert Man or “S.A.M.”

3) The device of claim 1, wherein said awareness campaign further comprises the steps of:
marketing and advertising through media, character appearances and education of young individuals and drivers.

4) The device of claim 1, wherein said physical implementation further comprises the steps of:
utilizing a dynamic, inflatable sign that is powered by a blower motor.

5) The device of claim 1, wherein said physical implementation further comprises the steps of:
providing individuals with a static, inflatable sign that is attachable to a broken down vehicle.

6) The device of claim 1, wherein said physical implementation further comprises the steps of:
providing individuals with a static, inflatable sign that is supports a sign that is adapted to be placed ahead of a broken down vehicle or pedestrian crossing.

7) The device of claim 1, wherein said physical implementation further comprises the steps of:
utilizing said character sign at pedestrian crosswalks, along construction sites, for roadways hazards and for broken down vehicles along roadways.
